(19) United States
(12) Patent Application Publication
(10) Pub. No.: US 2010/0145354 A1
(43) Pub. Date: Jun. 10, 2010

(54) ANIMAL TAG APPLICATOR

(76) Inventor: Keith Kuhnly, Lino Lakes, MN (US)

Correspondence Address: STROOCK & STROOCK & LAVAN LLP, 180 MAIDEN LANE, NEW YORK, NY, 10038, US

(21) Appl. No.: 12/629,367

(22) Filed: Dec. 2, 2009

Related U.S. Application Data
(60) Provisional application No. 61/119,932, filed on Dec. 4, 2008.

(51) Int. Cl. A01K 11/00

(52) U.S. Cl. 606/117

(57) ABSTRACT

An animal tag applicator that comprises a lever member having an attachment member, a base portion having a release member, an aperture configured to receive the attachment member when the attachment member is brought into contact with the base portion and a holding mechanism that extends between the release member and aperture. The applicator preferably further comprises an application member where the lever member and application member are pivotally coupled to the base portion at a pivot mechanism and a spring member coupled between the lever member and the base portion. When the release member is actuated, the holding mechanism detaches from the attachment member, the spring member expands and the application member is brought towards the base portion to apply an animal tag.

### CROSS-REFERENCE TO RELATED APPLICATION

This application claims the benefit of U.S. Provisional Application Ser. No. 61/119,932 filed Dec. 4, 2008, entitled “APPLICATOR” the entire disclosure of which is incorporated by reference herein.

### BACKGROUND OF THE INVENTION

1. Field of the Invention

The present invention relates generally to an improved animal tag applicator for applying tags to animals and livestock.

2. Description of Related Art

Over the past few years, the identification or tagging of animals such as swine, sheep, cattle and other livestock at a farm or slaughter facility has become increasingly important. Producers and farmers typically tag such animals in order to maintain proper identification from birth in order to track the whereabouts of the animal, genetic performance and/or provide disease control. These tags typically consist of two pieces. A male portion which has a pointed projection that is inserted through the animal's ear and a female retaining portion that can retain the projection of the male portion.

In order to apply the tag to the animal, an operator would typically use an applicator that is able to grasp the opposing portions of the tag and couple them through the ear of the animal. Prior art tag applicators are typically lever based (similar to pliers) and rely on the strength of an operator's hand or hands to provide the force required to insert the stud through the animal's ear and into the female tag. This can be difficult as the force required to provide this insertion and ensure that the tag is properly secured can be in excess of one hundred pounds. Additionally, prior art applicators typically have little or no built-in mechanical advantage to help close the handles of the applicator. One reason for this is that adding such a feature would typically increase the separation of the handles or increase the applicator size which can further complicate its closure.

In practice, after a prior-art applicator is loaded with the opposing portions of the tag, the operator will then approach the animal and grab the animal's ear with one hand to position the ear properly for application of the tag. Next the operator would need to move the applicator towards the ear so the tag is positioned properly on each side of the ear and then begin to close the applicator by squeezing the applicator with their hand. Because of the difficulty and strength necessary to close the applicator, the operator may be required to release the ear of the animal in order to grab the applicator handles with both of their hands to provide enough force to complete the applicator closure. These extra steps increase the time required to close the applicator and increase the safety risk for the operator and animal because of the elongated time that the animal can move or thrash its head due to the induced pain during this tag application.

Additionally, because of the extra force required to apply the tags, operators may become easily fatigued and exert insufficient force to completely insert the stud into the female tag which will compromise the tag's ability to be retained in the animal's ear. This can result in a high rate of tag loss or tags falling out of the animals ears over time.

Therefore, a need exists for an applicator that is designed to ease and expedite the tag application process.

### SUMMARY OF THE INVENTION

The present invention satisfies one or more of the foregoing and/or other deficiencies in the art. According to an embodiment of the present invention, the animal tag applicator comprises a lever member having an attachment member, a base portion having a release member, an aperture configured to receive the attachment member when the attachment member is brought into contact with the base portion and a holding mechanism that extends between the release member and aperture. The applicator preferably further comprises an application member, where the lever member and application member are pivotally coupled to the base portion at a pivot mechanism and a spring member coupled between the lever member and the base portion. When the release member is actuated the holding mechanism detaches from the attachment member, the spring member expands and the application member is brought into contact with the base portion to apply an animal tag.

In an embodiment of the present invention, the animal tag applicator comprises a lever member having an attachment member, a lever attachment that is removably coupled to the lever member, and a base portion having a release member, an aperture configured to receive the attachment member when the attachment member and the lever attachment are brought into contact with the base portion and a holding mechanism that extends between the release member and aperture. The applicator preferably also comprises an application member, where the lever member and application member are pivotally coupled to the base portion at a pivot mechanism and a spring member. When the release member is actuated the holding mechanism detaches from the attachment member, the spring member expands and the application member is brought into contact with the base portion to apply an animal tag.

In one embodiment of the present invention, a method of applying an animal tag to an animal using an applicator that has a lever member, an application member and a base portion includes rotating the lever member so that it compresses a spring member that is coupled between the lever member and base portion, coupling the lever member and base portion via an attachment member and a holding mechanism, positioning the applicator relative to the animal so that the animal tag can be applied in an appropriate position on the animal, and actuating a release member to detach the attachment member from the holding mechanism which expands the spring member and brings the application member into contact with the base portion to apply the animal tag.

### BRIEF DESCRIPTION OF THE DRAWINGS

The foregoing summary, as well as the following detailed description of preferred embodiments of the application, will be better understood when read in conjunction with the accompanying drawings. For the purposes of illustrating the applicator of the present application, there is shown in the drawings preferred embodiments. The drawings are not intended to limit the scope of this invention, but merely to clarify and be illustrative of embodiments of the invention. It should be understood, that the application is not limited to the precise arrangement, structures, features, embodiments, aspects, and instrumentalities shown, and the arrangements, structures, features, embodiments, aspects and instrumentalities shown may be used singularly or in combination with other arrangements, structures, features, embodiments, aspects and instrumentalities. In the drawings:

FIG. 1 illustrates an animal tag applicator according to a first embodiment of the present invention;

FIG. 2 illustrates the animal tag applicator of FIG. 1 in a loaded position;

FIG. 3 illustrates the animal tag applicator of FIG. 1 after the release member has been actuated;

FIG. 4 illustrates an animal tag applicator according to a second embodiment of the present invention; and

FIG. 5 illustrates the animal tag applicator of FIG. 4 after the release member has been actuated.

### DETAILED DESCRIPTION OF CERTAIN EMBODIMENTS

Certain exemplary embodiments of the present invention will now be discussed with reference to the aforementioned figures wherein like reference numerals refer to like components. In general, such embodiments relate to an improved animal tag applicator for applying tags for tracking animals and livestock. As described in greater detail below, and as will be appreciated by those skilled in the art, the size and shape of the animal tag applicator disclosed in the various embodiments herein or the parts thereof can be varied without departing from the spirit of the present invention.

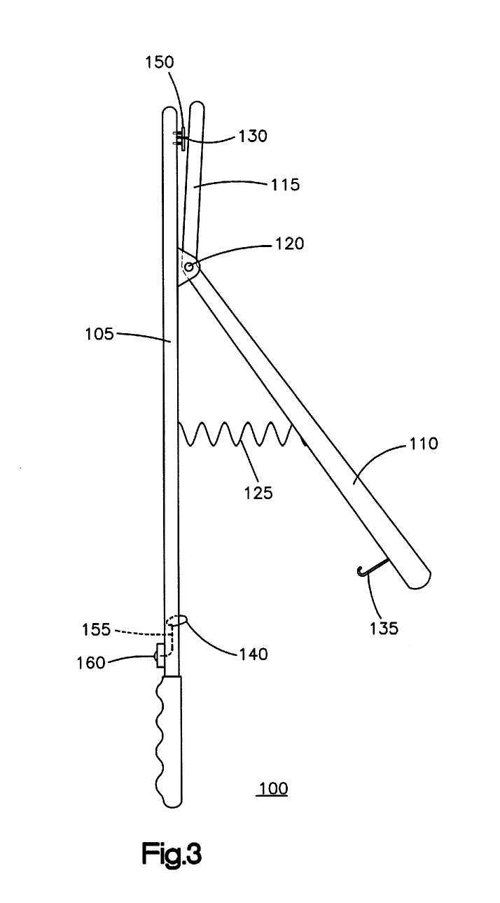

Referring to FIGS. 1-3, a first embodiment of an animal tag applicator 100 includes a base portion 105, a lever member 110 and an application member 115. Lever member 110 and application member 115 are pivotally coupled to each other at a pivot mechanism 120. Pivot mechanism 120 is preferably a fulcrum pin that allows the lever member and application member to axially pivot relative to each other and relative to the base portion 105. However as will be appreciated by one with ordinary skill in the art, a bolt, rivet or other coupling mechanism that still enables the lever member 110 and application member 115 to axially pivot relative to each other can be used. Although any material can be used, the lever member 110, application member 115 and base portion 105 are preferably each made out of a sturdy metallic or a plastic material or the like, although the material may be covered or supplemented by a rubber like material in locations where the user needs to grasp the applicator.

Application member 115 connects to pivot mechanism 120 on its distal end and preferably includes a pin member 130 that protrudes near its proximal end. Pin 130 is preferably distanced between 2 and 5 inches away from pivot mechanism 120 and more preferably between 2.5 and 3.2 inches away from pivot mechanism 120. Pin member 130 is fashioned in such a manner that it is able to receive and be inserted into the stud member of an animal tag. In one embodiment, pin member 130 may be a tipping pin. A tipping pin is a pin that can rotate at least 45 degrees out of the stud to ease withdrawal of the applicator after the tag has been applied to the animal. In order to be able to rotate out of the stud, the tipping pin typically has a mechanical mechanism that enables it to rotate and slip out of the stud once the stud is inserted into the female portion of the tag or substantially inserted therein. As can be appreciated by one with ordinary skill in the art, the tipping pin needs to be produced in such a size and manner that it friction fits into the stud so that the stud is not movable relative to the pin when they are coupled but the tipping pin is still able to rotate out of the stud once the tag has been applied. In yet another embodiment, application member 115 need not contain a pin member 130 but can still be used to apply a single piece tag or a two piece tag that does not have a stud portion that would utilize an applicator pin.

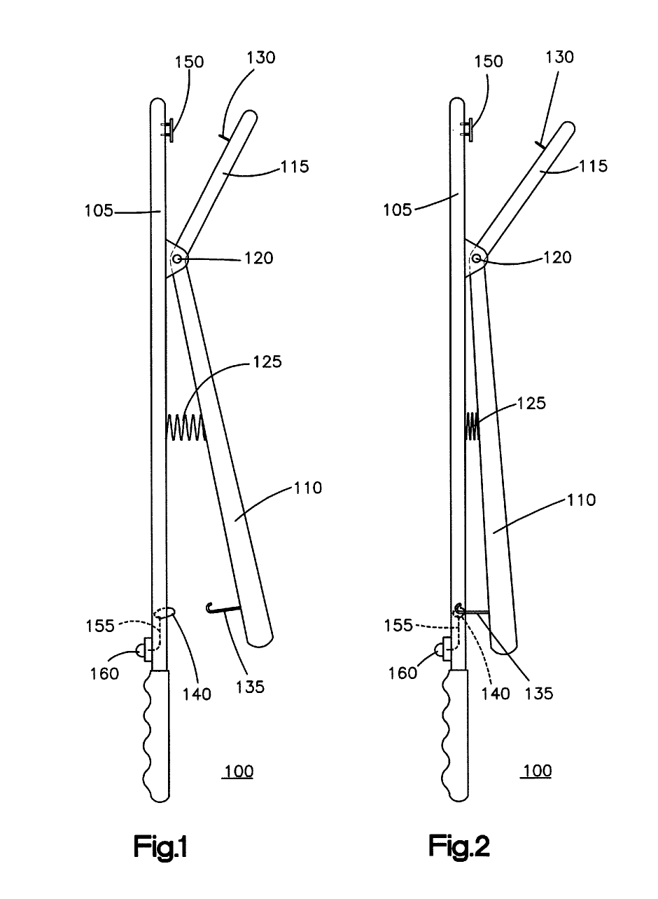

Lever member 110 which is preferably at least 2 to 3 times longer than application member 115 connects to pivot 120 at its distal end opposite application member 115. Attachment member 135 is coupled to lever member 110 and allows the lever member 110 to be coupled to the base portion 105 when the lever member 110 is depressed as can be seen in FIG. 2. Attachment member 135 is preferably a hook although it can be any attachment mechanism, that will allow the lever member 110 to be temporarily attached to the base portion 105, as will be appreciated by one with ordinary skill in the art. Spring member 125 is attached to both lever member 110 and base portion 105 and allows the user of applicator 100 to create tension when the lever member 110 is depressed and brought into contact with the base portion 105. Spring member 125 is preferably a compression spring that creates mechanical energy when force is exerted onto it and the spring member is condensed, although any shape, size, or type of coil member or other type of spring can be used to create the same mechanical energy as will be appreciated by one of ordinary skill in the art. Additionally or in lieu of spring member 125, a spring member (not shown) may be incorporated as part of pivot mechanism 120 as can be appreciated by one with ordinary skill in the art.

Base portion 105 has a length that is greater that the sum of the length of the application member 115 and the lever member 110. Base portion 105 preferably contains a receiving member 150 at its proximal end that is configured to hold the female portion of the animal tag and is positioned to receive the pin 130 (and the stud that is attached thereto) when the application member 115 is brought in contact with the base portion 105. Base portion 105 also preferably contains an aperture 140 that is adapted to receive attachment member 135 when the lever member 110 is brought in contact with the base portion 105. A holding mechanism 155 is located within aperture 140 which holding mechanism connects on its proximal end to a release member 160 and can be coupled to the attachment member 135 on its distal end when the lever member 110 is brought in contact with base portion 105. Release member 160 is a trigger-type element that when depressed will draw holding mechanism 155 towards the distal end of the base portion 105. Although shown in a rectangular shape, base portion can take on any varying shapes or be altered to include additional features. For example, in one embodiment, base portion 105 may have a protruding portion at its distal end that is substantially perpendicular to base portion 105 to form the shape of a gun handle. This will allow easier gripping for the user when applying the tag to the animal or releasing the lever member 110.

In operation, when a user desires to prepare applicator 100 to apply a tag to an animal, the user inserts the female portion of the tag into receiving member 150 and attaches the male portion of the tag onto the application member 115 such as for example by inserting the stud portion onto pin 130. The user would then depress lever member 110 so it comes in contact with base portion 105. As can be appreciated by one with ordinary skill in the art, depressing lever member 110 will compress spring member 125 and create mechanical energy. Additionally, bringing lever member 110 into contact with base portion 105 causes attachment member 135 to enter aperture 140 and couple with holding mechanism 155 as can be seen in FIG. 2. At that point, the applicator 100 is prepared to apply the tag to the animal.

The user of the applicator can then approach the animal that is to be tagged and prepare the location for the tag (e.g., the ear). The open area of applicator 100 that is between pin 130 and receiving member 150 is then placed over the ear of the animal. Once the applicator has been correctly positioned, over the ear for example, the user depresses release member 160 which draws the holding mechanism 155 away from the proximal end of base portion 105 and towards release member 160 which in turn detaches the holding mechanism 155 from the attachment member 135. Once the attachment member 135 has been released, the stored up mechanical energy in spring member 125 is released causing the lever member 110 to snap away from the base portion 105 and the application member 115 to snap towards base portion 105 which appropriately applies the tag to the animal. This allows the user to use a single hand to control the applicator while utilizing his or her free hand to control or subdue the animal.

Once the tag has been attached to the animal, the applicator can be safely removed from the animal's ear. As mentioned above, pin 130 may be a tipping pin that can rotate away from the animal's ear once the tag has been properly applied. Alternatively, an additional spring that is coupled to the application member 115 and the base portion 105 may be used to cause the application member 115 to automatically snap back away from the base portion 105 after the tag has been applied. Alternatively, a spring or other similar mechanism may be inserted as part of the pivot mechanism 120 to cause the application member 115 to actuate away from the animal once the tag has been applied.

As will be appreciated by one with ordinary skill in the art, the relative sizes of the lever member 110 and the application member 115 and the location of the spring member 125 relative to the pivot mechanism 120 will result in a different amount of force applied to spring member 125. Therefore in a most preferred embodiment, lever member 110 will be at least 2 to 3 times the size of application member 115 so that additional force can be applied when lever member 115 is depressed and the mechanical force in spring member 125 will be great enough to apply a strong enough force when the application member snaps into contact with the base portion 105.

In one embodiment as will be appreciated with ordinary skill in the art, any or all of the components of the applicator 100 can be combined or separated. For example application member 115 and lever member 110 may be combined into a single piece. In this embodiment, the single piece may be actuated into a substantially parallel position with base portion 105 and be depressed to couple with base portion 105 using aperture 140 and holding mechanism 155 as discussed above. The single piece can then be released to apply the tag in the same manner that the application member applies the tag as discussed above.

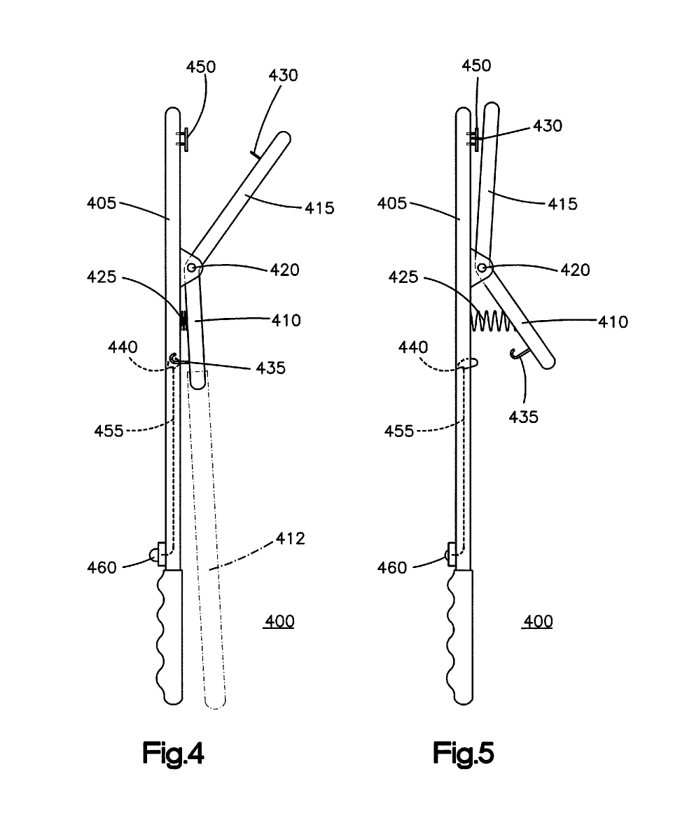

A second embodiment of the animal tag applicator will now be discussed with reference to FIGS. 4-5. Animal tag applicator 400 includes a base portion 405, a lever member 410 a removable lever attachment 412 and an application member 415. Similar to the first embodiment, lever member 410 and application member 415 are preferably pivotally coupled to each other at a pivot mechanism 420. In the present embodiment pivot mechanism 420 may also have a spring member incorporated therein to provide mechanical force when lever member 410 is brought in contact with base portion 405. Pivot mechanism may incorporate a fulcrum pin or other bolt or rivet as can be appreciated by one with ordinary skill in the art that enables the lever member 410 and application member 415 to axially pivot relative to each other and relative to base portion 405.

Similar to the first embodiment, application member 415 connects to pivot 420 on its distal end and preferably includes a pin member 430 on its proximal end. Pin member 430 is fashioned in such a manner that it is able to receive and be inserted into the stud member of an animal tag. In one embodiment, pin member 430 may be a tipping pin as discussed above.

In the present embodiment, lever member 410 has the same or a smaller length than application member 415. Removable lever attachment 412 is removably coupled to lever member 410 and allows the user of the animal tag applicator 400 to more easily depress lever member 410 when the applicator 400 is being prepared to apply the tag to the animal. Thus use of a shorter lever member at the time of applying the tag avoids any potential injury that may be caused when the lever portion snaps upwards to apply the tag to the animal. Removable lever attachment 412 can be removably coupled to lever member 410 using any heretofore known or hereafter developed attachment mechanism such as a screw, bolt, tab or the like. Alternatively, removable lever attachment 412 could be hollow and slide over the top of lever member 410.

In one embodiment, attachment member 435 is coupled to lever member 410 and allows the lever member 410 to be coupled to the base portion 405 when the lever member 410 is depressed as can be seen in FIG. 4. In one embodiment, spring member 425 is attached to both lever member 410 and base portion 405 and allows the user of applicator 400 to create tension when the lever member 410 is depressed and brought into contact with the base portion 405. Spring member 425 is preferably a compression spring that creates mechanical energy when force is exerted onto it and the spring member is condensed, although any shape, size, or type of coil member or other type of spring can be used to create the same mechanical energy as will be appreciated by one of ordinary skill in the art. As discussed above, additionally or in lieu of spring member 425, a torsional spring member (not shown) may be incorporated as part of pivot mechanism 420 as can be appreciated by one with ordinary skill in the art.

Base portion 405 has a length that is preferably greater that the sum of the length of the application member 415, the removable lever attachment 412 and the lever member 410. Base portion 405 preferably contains a receiving member 450 at its proximal end that is configured to hold the female portion of the animal tag and is positioned to receive the pin 430 when the application member 415 is brought in contact with the base portion 405. Base portion 405 also preferably contains an aperture 440 that is adapted to receive attachment member 435 when the lever member 410 is brought in contact with the base portion 405. A holding mechanism 455 is located within aperture 440 which holding mechanism 455 connects on its proximal end to a release member 460 and can be coupled to the attachment member 435 on its distal end when the lever member 410 is brought into contact with the base portion 405. Release member 460 is preferably a trigger-type element that when depressed will draw holding mechanism 455 towards the distal end of the base portion 405.

In operation, when a user desires to apply a tag to an animal using applicator 400, the user inserts the female portion of the tag into receiving member 450 and couples the male portion of the tag onto the application member 415 such as for example by inserting the stud portion onto pin 430. The user would then assure that removable lever attachment member 412 is attached to lever member 410 and depress removable lever attachment 412 downward toward base portion 405 so that both lever member 410 comes into contact with base portion 405. As can be appreciated by one with ordinary skill in the art, using an elongated lever attachment to depress lever member 410 creates added mechanical leverage to compress spring member 425 that would not have been present if only lever member 410 was used to compress spring member 425. Additionally, it should be appreciated that it would be easier for a user of the applicator 400 to depress lever member 410 using attachment 412 rather than having to depress lever member 410 by itself.

Alternatively in one embodiment as mentioned above, a spring mechanism may be part of pivot mechanism 420 which spring mechanism can likewise be compressed when lever attachment 412 is used to bring lever member 410 in contact with base portion 405. Additionally, bringing lever member 410 towards the base portion 405 causes attachment member 435 to enter aperture 440 and couple with holding mechanism 455 as can be seen in FIG. 4. At that point, the user can disengage the removable lever attachment 412 from lever member 410, which prepares the applicator 400 to apply the tag to the animal. Since attachment member 435 has been coupled with the holding mechanism 455, lever member 410 will remain in its position on base member 405 until the user of the applicator decides to release it using the release member 460.

The user can then approach the animal and prepare the location for the tag (e.g., the ear). The open area of applicator 400 between pin 430 and receiving member 450 is then placed over the ear of the animal. Once the applicator has been correctly positioned, over the ear for example, the user depresses release member 460 which draws the holding mechanism 455 towards release member 460 and detach the holding mechanism 455 from the attachment member 435. Once the attachment member 435 has been released, the stored mechanical energy in spring member 425 (and/or the spring in pivot mechanism 420) causes the lever member 410 to snap away from the base portion 405 which in turn causes the application member 415 to snap towards base portion 405 to appropriately apply the tag to the animal.

Once the tag has been attached to the animal, the applicator 400 can be safely removed from the animal's ear. As mentioned above, pin 430 may be a tipping pin that can rotate away from the animal's ear once the tag has been properly applied. Alternatively, an additional spring that is coupled to the application member 415 and the base portion 405 may be used to cause the application member 415 to snap back away from the base portion 405 after the tag has been applied. The user can then reattach removable lever attachment 412 and prepare the applicator 400 to apply another tag to another animal.

Additionally, in one embodiment, the applicator may not have a lever member at all. Rather, in such an embodiment, a removable attachment may be inserted directly into a slot in the pivot mechanism and as the removable attachment is moved towards the base portion the spring member in the pivot mechanism may be compressed and an attachment member in the pivot mechanism may couple the pivot mechanism to the base member. Similar to the embodiments discussed above, a release mechanism can then be actuated to release the attachment member and cause the application member to snap towards the base member.

It should be noted that although the device described above is described in terms of specific shapes and sizes other embodiments of the present invention could be implemented using different materials, shapes and sizes. For example, although the applicator has been described as being in a certain shape or configuration, additional configurations or shapes can also be used without departing from the spirit of the invention. Moreover although the applicator is described as being used primarily to apply a multi-part tag, the applicator can be designed to apply unitary tags as well. The precise design of the applicator and method of applying the animal tags may be altered and remain within the scope of the present invention. Those skilled in the art recognize that the present invention has many applications, may be implemented in many manners and, as such, is not to be limited by the foregoing exemplary embodiments and examples. In this regard, any number of the features of the different embodiments described herein may be combined into one single embodiment. Moreover, the scope of the present invention covers conventionally known and future developed variations and modifications to the tag and components described above as would be understood by those skilled in the art. It is the intention, therefore, to be limited only as indicated by the scope of the claims appended hereto.

It is also to be understood that the following claims are intended to cover all of the generic and specific features of the invention herein described and all statements of the scope of the invention, which, as a matter of language, might be said to fall therebetween.

1. An animal tag applicator comprising:
a lever member having an attachment member;
a base portion having a release member, an aperture configured to receive the attachment member when the attachment member is brought into contact with the base portion and a holding mechanism that extends between the release member and aperture;
an application member, where the lever member and application member are pivotally coupled to the base portion at a pivot mechanism; and
a spring member coupled between the lever member and the base portion;
wherein when the release member is actuated, the holding mechanism detaches from the attachment member, the spring member exerts its stored energy and the application member is brought towards the base portion to apply an animal tag.

2. The animal tag applicator of claim 1, wherein the application member comprises a pin configured to receive at least a portion of the animal tag.

3. The animal tag applicator of claim 2, wherein the pin is a tipping pin.

4. The animal tag applicator of claim 2, wherein the base portion further comprises a receiving member configured to receive at least a portion of the animal tag.

5. The animal tag applicator of claim 1, wherein the attachment member is a hook.

6. The animal tag applicator of claim 1, wherein the spring member is situated between the aperture and the pivot mechanism.

7. The animal tag applicator of claim 1, wherein the spring member is a torsional spring or a compression spring.

8. The animal tag applicator of claim 1, further comprising a coil member that permits the application member to rotate away from the base member once the animal tag has been applied.

9. The animal tag applicator of claim 1, wherein the animal tag comprises more than one piece.

10. The animal tag applicator of claim 1, wherein the application member and lever member are a single piece.

11. An animal tag applicator comprising:
a lever member having an attachment member;
a lever attachment that is removably coupled to the lever member;
a base portion having a release member, an aperture configured to receive the attachment member when the attachment member is brought towards the base portion and a holding mechanism that extends between the release member and aperture;
an application member, where the lever member and application member are pivotally coupled to the base portion at a pivot mechanism; and
a spring member;
wherein when the release member is actuated, the holding mechanism detaches from the attachment member, the spring member exerts its stored energy and the application member is brought towards the base portion to apply an animal tag.

12. The animal tag applicator of claim 11, wherein the spring member is coupled between the lever member and the base portion.

13. The animal tag applicator of claim 12, wherein the spring member is situated between the aperture and the pivot mechanism.

14. The animal tag applicator of claim 11, wherein the spring member is coupled to the pivot mechanism.

15. The animal tag applicator of claim 11, wherein the application member comprises a pin configured to receive at least a portion of the animal tag.

16. The animal tag applicator of claim 15, wherein the pin is a tipping pin.

17. The animal tag applicator of claim 15, wherein the base portion further comprises a receiving member configured to receive at least a portion of the animal tag.

18. The animal tag applicator of claim 11, further comprising a coil member that permits the application member to rotate away from the base member once the animal tag has been applied.

19. The animal tag applicator of claim 11, wherein the application member and lever member are a single piece.

20. A method of applying an animal tag to an animal using an applicator that has a lever member, an application member and a base portion, the method comprising:
rotating the lever member so that it compresses a spring member that is coupled between the lever member and base portion;
coupling the lever member and base portion via an attachment member and a holding mechanism;
positioning the applicator relative to the animal so that the animal tag can be applied in an appropriate position on the animal; and
actuating a release member that detaches the attachment member from the holding mechanism, permits the spring member to release its stored energy and brings the application member towards the base portion to apply the animal tag.
